(19) United States
(12) Patent Application Publication
(10) Pub. No.: US 2016/0148436 A1
(43) Pub. Date: May 26, 2016

(54) ELECTRONIC DEVICE AND METHOD FOR PROCESSING POINT CLOUD OF OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); LING ZHANG, Shenzhen (CN); HENG ZHANG, Shenzhen (CN)

(21) Appl. No.: 14/726,768

(22) Filed: Jun. 1, 2015

(30) Foreign Application Priority Data
Nov. 21, 2014 (CN) 201410673564.1

(51) Int. Cl. G06T 19/20; G06T 7/00

(52) U.S. Cl. CPC G06T 19/20; G06T 7/003; G06T 2207/10028; G06T 2207/20221; G06T 2219/2004; G06T 2207/20048

(57) ABSTRACT

Framework for processing a point cloud of an object includes an electronic device coupled to a testing device. The testing device includes a worktable and a scanning device. The worktable has a number of labeled points. The electronic device controls the worktable to rotate at predetermined angles of rotation, and controls the scanning device to scan the worktable at each angle of rotation. A number of sets of points scanned by the scanning device is obtained. A transformation matrix of the sets of points is calculated according to coordinate positions of the labeled points of each set of points. A number of point cloud sets of an object placed on the worktable is obtained by scanning the object at corresponding angles of rotation. The point cloud sets are combined to obtain an overall point cloud according to the transformation matrix, and overlapping points of the overall point cloud are removed.

### FIELD

The subject matter herein generally relates to point clouds, and more particularly to an electronic device and a method for processing a point cloud of an object obtained by scanning the object from a plurality of different angles.

### BACKGROUND

Generally, a point cloud of an object is obtained by scanning a surface of the object. The point cloud represents contours of the surface of the object. The object may need to be scanned from different angles to obtain the point cloud, in which case some points of the point cloud may overlap with each other.

### BRIEF DESCRIPTION OF THE DRAWINGS

Implementations of the present technology will now be described, by way of example only, with reference to the attached figures.

FIG. 1 is a block diagram of an embodiment of an electronic device and a testing device, the electronic device implementing a cloud processing system.

FIG. 2 is a block diagram of an embodiment of function modules of the cloud processing system of FIG. 1.

FIG. 3 is a flowchart diagram of an embodiment of a method for processing a point cloud of an object.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

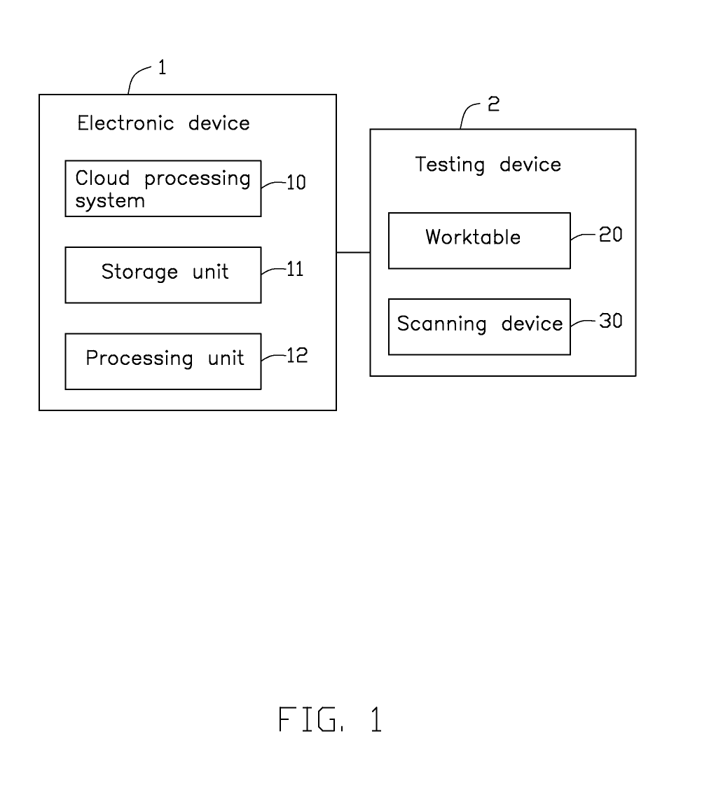

FIG. 1 illustrates an embodiment of an electronic device 1 implementing a cloud processing system 10 for processing a point cloud of an object. The electronic device 1 can be coupled to a testing device 2. The electronic device 1 can include a storage unit 11 and a processing unit 12. The testing device 2 can include a worktable 20 and a scanning device 30. The worktable 20 can rotate at predetermined angles of rotation, and the scanning device 30 can scan the worktable 20. The cloud processing system 10 can obtain a plurality of sets of points of the object scanned by the scanning device 30 and remove overlapping points to simplify the point cloud. In at least one embodiment, the electronic device 1 can be a personal computer, a server, or the like.

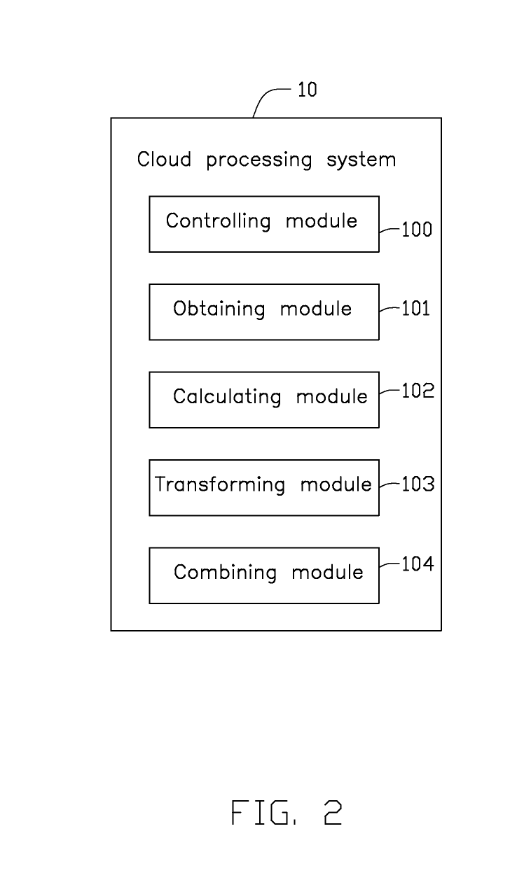

Referring to FIG. 2, the point cloud processing system 10 can include a plurality of modules, such as a controlling module 100, an obtaining module 101, a calculating module 102, a transforming module 103, and a combining module 104. The modules 100-104 can include one or more software programs in the form of computerized codes stored in the storage unit 11. The computerized codes can include instructions executed by the processing unit 12 to provide functions for the modules 100-104.

The worktable 20 can have a plurality of labeled points thereon. The controlling module 100 can control the worktable 20 to rotate at the predetermined angles of rotation and control the scanning device 30 to scan the surface of the worktable 20 at each angle of rotation to scan the plurality of labeled points.

The obtaining module 101 can obtain a plurality of sets of points scanned by the scanning device 30. Each set of points can include all of the labeled points and correspond to one angle of the worktable.

The calculating module 102 can determine a positional relationship between every two adjacent sets of points. The positional relationship can be determined by at least one of a plurality of constraint conditions of Euclidean space. The constraint conditions can include a distance constraint, an angle constraint, and a surface area constraint. For example, to determine the position relationship according to the distance constraint, the calculating module 102 can first calculate a coordinate position of each labeled point of a set of points, and calculate a distance table recording a distance between every two points of the set of points. For example, a distance between a first point Q1 and a second point Q2 of a first set of points can be recorded as {S, Q1, Q2}, wherein S equals the distance between the first point Q1 and the second point Q2. The calculating module 102 can calculate a distance table for every set of points. The distance tables can be saved in the storage unit 11. After the distance tables are calculated, the calculating module 102 can match a distance between any two points of one set of points to a distance between corresponding two points of another set of points. The distances between every two points of one set of points can be matched to distances between corresponding two points of another set of points to determine the positional relationship between the two sets of points.

The transforming module 103 can calculate a transformation matrix of the plurality of sets of points according to the positional relationships for aligning each set of points to a same visual angle. The transformation matrix can be calculated according to trigonometry, a least square method, singular value decomposition, or a quaternion algorithm, for example.

After the transformation matrix is calculated, the object can be placed on the worktable 20, and the controlling module 100 can control the worktable 20 to rotate and the scanning device 30 to scan the object from the plurality of angles. The obtaining module 101 can obtain a plurality of point cloud sets of the object, and obtain a coordinate point of each point of each point cloud set. Each point cloud set can correspond to one angle of rotation of the worktable 20.

The combining module 104 can combine the plurality of point cloud sets according to the transformation matrix to obtain an overall point cloud of the object. The combining module 104 can determine a plurality of overlapping points of the overall point cloud, and remove the overlapping points to obtain a simplified point cloud of the object. Thus, a size of the overall point cloud is effectively reduced, and the overall point cloud is effectively simplified.

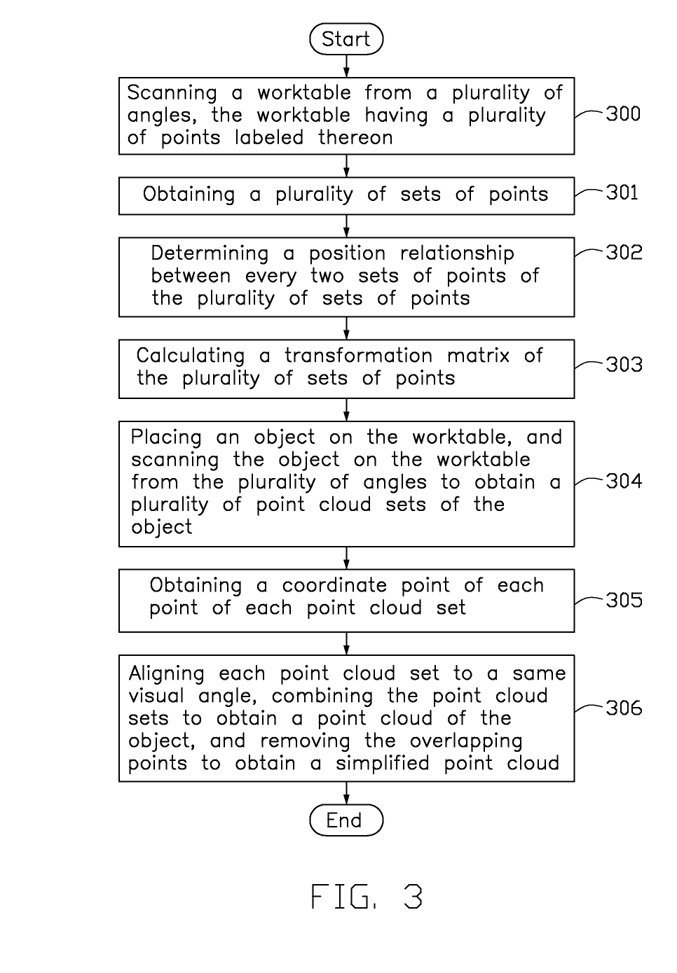

FIG. 3 illustrates a flowchart of an exemplary method for processing a point cloud of an object. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 300.

At block 300, a worktable having a plurality of labeled points can be controlled by an electronic device to rotate at predetermined angles of rotation, and the electronic device can control a scanning device to scan the worktable from a plurality of angles.

At block 301, the electronic device can obtain a plurality of sets of points scanned by the scanning device. Each set of points of the plurality of sets of points can correspond to one angle of the worktable.

At block 302, the electronic device can determine a positional relationship between every two adjacent sets of points of the plurality of sets of points. In detail, the electronic device can first calculate a coordinate position of each labeled point of each set of points, and calculate a distance table recording a distance between every two points of each set of points. For example, a distance between a first point Q1 and a second point Q2 of a first set of points can be recorded as {S, Q1, Q2}, wherein S equals the distance between the first point Q1 and the second point Q2. A distance table for every set of points can be calculated. After the distance tables are calculated, the electronic device can match a distance between any two points of one set of points to a distance between corresponding two points of another set of points. The distances between every two points of one set of points can be matched to distances between corresponding two points of another set of points to determine the positional relationship between the two sets of points.

At block 303, the electronic device can calculate a transformation matrix of the plurality of sets of points according to the positional relationships for aligning each set of points to a same visual angle. The transformation matrix can be calculated according to trigonometry, a least square method, singular value decomposition, or a quaternion algorithm, for example.

At block 304, an object can be placed on the worktable, and the object can be scanned from the plurality of angles to obtain a plurality of point cloud sets of the object.

At block 305, the electronic device can obtain a coordinate point of each point of each point cloud set.

At block 306, the electronic device can align each point cloud set to a same visual angle, and combine the point cloud sets to obtain an overall point cloud of the object. The electronic device can determine overlapping points of the overall point cloud and remove the overlapping points to obtain a simplified point cloud.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for processing a point cloud of an object, the method comprising:
scanning, by a scanning device, a worktable from a plurality of angles, the worktable having a plurality of points labeled thereon, and the plurality of angles achieved by rotating the worktable at a predetermined angle of rotation;
obtaining, from the scanning device, a plurality of sets of points scanned by the scanning device, each set of points corresponding to one of the plurality of angles of the worktable, and each point of each set of points corresponding to one labeled point of the plurality of points of the worktable;
determining a positional relationship between every two adjacent sets of the plurality of sets of points;
calculating, according to the positional relationships, a transformation matrix of the plurality of sets of points;
scanning, by the scanning device, an object placed on the worktable from the plurality of angles to obtain a plurality of point cloud sets of the object;
obtaining, from the scanning device, a coordinate point of each point in each of the plurality of point cloud sets;
aligning each point cloud set to a same visual angle according to the transformation matrix;
combining the point cloud sets according to the transformation matrix to obtain an overall point cloud of the object;
determining overlapping points of the overall point cloud; and
removing the overlapping points to obtain a simplified point cloud.

2. The method as in claim 1, wherein the positional relationship between every two adjacent sets of points is determined according to one of a plurality of constraint conditions of Euclidean space.

3. The method as in claim 2, wherein the constraint conditions comprise a distance constraint, an angle constraint, and a surface area constraint.

4. The method as in claim 3, wherein the positional relationship between two adjacent sets of points according to the distance constraint is determined by:
calculating a distance table recording a distance between every two points of a first set of points;
calculating a distance table recording a distance between every two points of a second set of points; and
matching the points of the first set of points to the points of the second set of points according to the distances between every two points of the first set of points and the second set of points.

5. The method as in claim 4, wherein the transformation matrix of the plurality of sets of points is calculated according to coordinate values of the points in each set of points.

6. The method as in claim 5, wherein a method for calculating the transformation matrix of the plurality of sets of points comprises at least one of trigonometry, a least square method, singular value decomposition, and quaternion algorithms.

7. An electronic device implementing a cloud processing system for processing a point cloud of an object, the electronic device coupled to a testing device, the electronic device configured to:
control a worktable of the testing device to rotate at predetermined angles of rotation, the worktable having a plurality of labeled points thereon;
control a scanning device of the testing device to scan the worktable from a plurality of angles while the worktable is rotating, each angle of the worktable corresponding to one of the predetermined angles of rotation;
obtain a plurality of sets of points scanned by the scanning device, each set of points corresponding to one of the plurality of angles of the worktable, and each point of each set of points corresponding to one labeled point of the worktable;
determine a positional relationship between every two adjacent sets of points of the plurality of sets of points;
calculate, according to the positional relationships, a transformation matrix of the plurality of sets of points;
control the worktable to rotate and the scanning device to scan when an object is placed on the worktable;
obtain a plurality of point cloud sets of the object from the scanning device;
align each point cloud set to a same visual angle according to the transformation matrix, and combine the point cloud sets according to the transformation matrix to obtain an overall point cloud of the object; and
determine overlapping points of the overall point cloud, and remove the overlapping points to obtain a simplified point cloud.

8. The electronic device as in claim 7, wherein the positional relationship between every two adjacent sets of points is determined according to one of a plurality of constraint conditions of Euclidean space.

9. The electronic device as in claim 8, wherein the constraint conditions comprise a distance constraint, an angle constraint, and a surface area constraint.

10. The electronic device as in claim 9, wherein the positional relationship between two sets of points according to the distance constraint is determined by:
calculating a distance table recording a distance between every two points of a first set of points;
calculating a distance table recording a distance between every two points of a second set of points; and
matching the points of the first set of points to the points of the second set of points according to the distances between every two points of the first set of points and the second set of points.

11. The electronic device as in claim 10, wherein the transformation matrix of the plurality of sets of points is calculated according to coordinate values of the points in each set of points.

12. The electronic device as in claim 11, wherein a method for calculating the transformation matrix of the plurality of sets of points comprises at least one of trigonometry, a least square method, singular value decomposition, and quaternion algorithms.

13. The electronic device as in claim 12 comprising:
a storage unit configured to store the distance table of each of the plurality of sets of points, and store a plurality of instructions of a plurality of modules of the cloud processing system; and
a processing unit configured to execute the plurality of instructions of the plurality of modules of the cloud processing system.

14. The electronic device as in claim 8, wherein the plurality of modules of the cloud processing system comprises:
a controlling module configured to control the worktable to rotate at the predetermined degrees of rotation, and control the scanning device to scan the worktable;
an obtaining module configured to obtain the plurality of sets of points scanned by the scanning device;
a calculating module configured to calculate the distance tables of the plurality of sets of points;
a transforming module configured to calculate the transformation matrix of the plurality of sets of points; and
a combining module configured to combine the plurality of point cloud sets to obtain the overall point cloud, and remove the overlapping points of the overall point cloud to obtain the simplified point cloud.

15. A framework for processing a point cloud of an object, the framework comprising:
an electronic device implementing a point cloud processing system; and
a testing device coupled to the electronic device, the testing device comprising a worktable and a scanning device;
wherein the worktable has a plurality of labeled points;
wherein the electronic device is configured to control the worktable to rotate at predetermined angles of rotation, and control the scanning device to scan the worktable at each of the predetermined angles of rotation;
wherein the electronic device is further configured to obtain a plurality of sets of points scanned by the scanning device, each set of points corresponding to one of the predetermined angles of rotation;
wherein the electronic device is further configured to calculate a transformation matrix of the plurality of sets of points according to coordinate positions of the labeled points of each set of points;
wherein the electronic device is further configured to obtain a plurality of point cloud sets of an object placed on the worktable, each point cloud set obtained by scanning the object at a corresponding angle of rotation; and
wherein the electronic device is further configured to combine the plurality of point cloud sets to obtain an overall point cloud according to the transformation matrix, and remove overlapping points of the overall point cloud to obtain a simplified point cloud.
